(19) United States
(12) Patent Application Publication
(10) Pub. No.: US 2017/0374552 A1
(43) Pub. Date: Dec. 28, 2017

(54) SMART NETWORKING METHOD AND SMART DEVICE

(71) Applicant: ZHEJIANG SHENGHUI LIGHTING CO., LTD, Jiaxing (CN)

(72) Inventors: JUN XIA, Jiaxing (CN); JINXIANG SHEN, Jiaxing (CN)

(21) Appl. No.: 15/543,983

(22) PCT Filed: Apr. 6, 2016
(86) PCT No.: PCT/CN2016/078532

§ 371 Date: Jul. 15, 2017

(30) Foreign Application Priority Data
May 12, 2015 (CN) 201510241195.3

(51) Int. Cl. H04W 12/08; H04W 12/06; H04W 48/10; H04W 48/16; H04L 29/06; H04W 84/12; H04W 76/00

(52) U.S. Cl. CPC H04W 12/08; H04W 48/16; H04W 12/06; H04L 63/083; H04W 48/10; H04W 76/002; H04W 84/12

(57) ABSTRACT

In accordance with various embodiments of the disclosed subject matter, a smart networking method, and a related smart device are provided. A smart networking method includes obtaining an identification of a WIFI hotspot; broadcasting connection information comprising the identification of the WIFI hotspot to prompt a user to choose whether to connect to the WIFI hotspot; collecting selection audio information from the user, and parsing the audio information to obtain a selection result of the user; in response to receiving the selection result selecting to connect to the WIFI hotspot, generating a password message for prompting the user to provide an access code of the WIFI hotspot, and broadcasting the password message; collecting password audio information from the user, parsing the password audio information to determine an access code of the WIFI hotspot, and connecting to the WIFI hotspot based on the access code.

### CROSS-REFERENCES TO RELATED APPLICATIONS

This PCT patent application claims priority of Chinese Patent Application No. 201510241195.3, filed on May 12, 2015, the entire content of which is incorporated by reference herein.

### TECHNICAL FIELD

The disclosed subject matter generally relates to the field of smart devices and, more particularly, relates to a smart networking method, and a related smart device.

### BACKGROUND

Along with the development of communication technologies and smart home technologies, more and more different types of terminal equipment have appeared in the market. Particularly, smart devices, such as smart home devices, are widely used in daily life.

Currently, a wide range of smart home devices are connected to the Internet over a wireless network, such as a Wireless-Fidelity (WIFI) network. Since many smart home devices have no display or input modules, they are usually connected to the Internet through an intermediate device, such as a smart phone or a tablet. An exemplary networking process can include the following steps: a smart home device starts a WIFI hotspot through a specific key; an intermediate device scans a two-dimensional code to install a specified application; the intermediate device then is connected to the smart home device; and by inputting an identification and a password of the WIFI hotspot through the application on the intermediate device, the smart home devices can be connected to a router via WIFI.

However, the existing networking method often requires an intermediate device to connect a smart home device to the network for the first time. Therefore the existing networking process for a smart home device is thus often complicated, and application scenarios for the smart home device may be limited.

Accordingly, it is desire to provide a smart networking method, and a related smart device.

### BRIEF SUMMARY

In accordance with some embodiments of the disclosed subject matter, a smart networking method, and a related smart device are provided.

An aspect of the present disclosure provides a smart networking method. In some embodiments, the method includes obtaining an identification of a first available WIFI hotspot; broadcasting connection information comprising the identification of the first available WIFI hotspot to prompt a user to choose whether to connect to the first available WIFI hotspot; and collecting selection audio information from the user, and parsing the audio information to obtain a selection result of the user. The method further includes in response to receiving the selection result selecting to connect to the first available WIFI hotspot, generating a password message for prompting the user to provide an access code of the first available WIFI hotspot, and broadcasting the password message; and collecting password audio information from the user, parsing the password audio information to determine an access code of the available WIFI hotspot, and connecting to the first available WIFI hotspot based on the access code.

Optionally, the method further includes obtaining a plurality of identifications of a plurality of available WIFI hotspots; and detecting a signal strength of each available WIFI hotspot. The plurality of available WIFI hotspots including the first available WIFI hotspot.

Optionally, the method further includes ranking the plurality of available WIFI hotspots based on the signal strengths of the available WIFI hotspots.

Optionally, the method further includes identifying the first available WIFI hotspot from the plurality of available WIFI hotspots based on the rank.

Optionally, the first available WIFI hotspot has a strongest signal strength.

Optionally, the first available WIFI hotspot is identified based on the rank and the selection audio information from the user.

Optionally, the method further includes parsing the password audio information to determine whether a password list includes at least one access code; and connecting to the first available WIFI hotspot based on the password list.

Optionally, the method further includes generating and broadcasting connection-successful information when the first available WIFI hotspot is being successfully connected to.

Optionally, the method further includes generating and broadcasting connection-failure information when the first available WIFI hotspot is not being successfully connected to.

Another aspect of the present disclosure provides a smart device. The smart device includes a processing module; a network scanning module configured for obtaining wireless networking information and transmitting the wireless networking information to the processing module; a voice broadcasting module configured for broadcasting a voice message transmitted from the processing module; and a voice detecting module configured for collecting user voice information and transmitting the user voice information to the processing module. Further, the processing module is configured for identifying a first available WIFI hotspot based on the wireless networking information transmitted from the network scanning module, generating a voice message and transmitting the voice message to the voice broadcasting module, and analyzing the user voice information transmitted from the voice detecting module.

Optionally, the wireless networking information comprises an identification of the first available WIFI hotspot and a signal strength of the first available WIFI hotspot.

Optionally, the processing module is further configured for ranking a plurality of available WIFI hotspots based on the signal strengths of the available WIFI hotspots.

Optionally, the voice message comprises the identification for the first available WIFI hotspot, and a first request message for asking whether the first available WIFI hotspot is to be selected.

Optionally, the voice message further comprises a second request message for asking a user to provide an access code of the first available WIFI hotspot.

Optionally, the voice message further comprises connection-successful information.

Optionally, the voice message further comprises connection-failure information.

Optionally, the processing module is further configured for parsing the user voice information to determine whether a password list includes at least one access code for connecting to the first available WIFI hotspot.

Optionally, the voice broadcasting module comprises at least one speaker.

Optionally, the voice detecting module comprises at least one microphone.

Optionally, the processing module comprises an automatic speech recognition module, a hardware processer, and a speech synthesis module.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements. It should be noted that the following drawings are merely examples for illustrative purposes according to various disclosed embodiments and are not intended to limit the scope of the present disclosure.

FIG. 1 is a flowchart of an exemplary smart networking method in accordance with some embodiments of the disclosed subject matter;

FIG. 2 is another flowchart of an exemplary smart networking method in accordance with some embodiments of the disclosed subject matter;

FIG. 3 is another flowchart of an exemplary smart networking method in accordance with some embodiments of the disclosed subject matter;

FIG. 4 is a flowchart of an implementation of a smart networking connection process in accordance with some embodiments of the disclosed subject matter;

FIG. 5 is an exemplary schematic structural diagram of a smart device in accordance with some embodiments of the disclosed subject matter;

FIG. 6 is another exemplary schematic structural diagram of a smart device in accordance with some embodiments of the disclosed subject matter; and

FIG. 7 is another exemplary schematic structural diagram of a smart device in accordance with some embodiments of the disclosed subject matter.

### DETAILED DESCRIPTION

For those skilled in the art to better understand the technical solution of the disclosed subject matter, reference will now be made in detail to exemplary embodiments of the disclosed subject matter, which are illustrated in the accompanying drawings. Wherever possible, the same reference numbers will be used throughout the drawings to refer to the same or like parts.

In accordance with various embodiments, the disclosed subject matter provides a smart networking method, and a related smart lighting device.

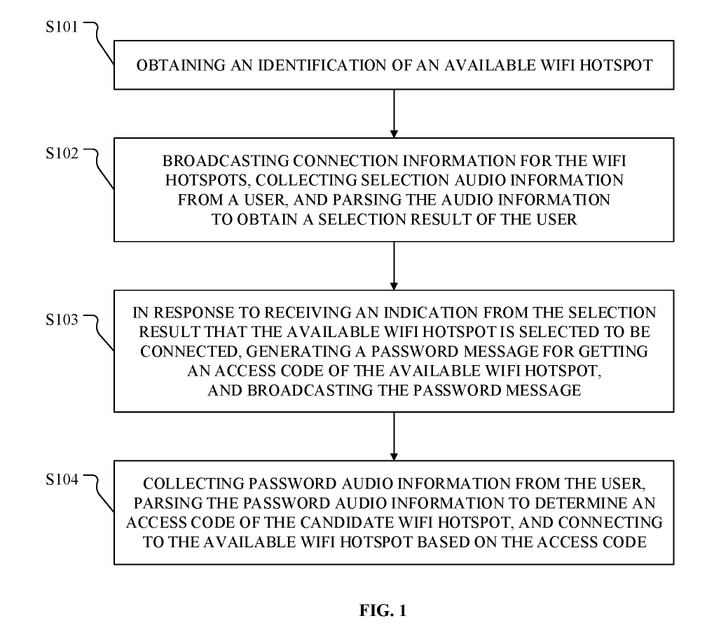

Referring to FIGS. 1-3, flowcharts of a smart networking method are shown in accordance with some embodiments of the disclosed subject matter. The smart networking method can be applied to any suitable smart networking devices, such as smart home appliances, including air conditioners, stereos, refrigerators, etc.

As illustrated in FIG. 1, the method can include the following steps.

S101: Obtaining an identification of an available WIFI hotspot.

After a smart device is powered on, it can scan for all available WIFI hotspots.

That is, the smart device can obtain one or more identifications of the WIFI hotspots to which it can be connected.

S102: Broadcasting connection information for the identified WIFI hotspots, collecting selection audio information from a user, and parsing the audio information to obtain a selection result of the user.

In some embodiments, the connection information includes one or more identifications of the WIFI hotspots and corresponding selection information. The selection information is used for prompting a user to choose whether to connect a WIFI hotspot.

In one embodiment, the smart device can audibly broadcast an identification of a WIFI hotspot, and ask whether the WIFI hotspot is selected to be connected by a user. The smart device can then collect selection audio information from the user, and parse the audio information to determine if the user wants to connect the smart device to the WIFI hotspot.

The smart device may be any smart appliances, such as a smart LED light, a smart refrigerator, s smart oven, etc., with smart networking capacities.

S103: In response to receiving an indication from the selection result that an available WIFI hotspot is selected to be connected, generating a password message for getting an access code of the WIFI hotspot, and broadcasting the password message.

In one embodiment, the smart applicant may use the message for prompting the user to provide an access code of the available WIFI hotspot. When the parsed selection result indicates that a connection to the available WIFI hotspot is selected, a password message for getting an access code of the available WIFI hotspot can be generated and broadcasted. For example, the smart device can audibly broadcast a password message to ask the user to input an access code of the WIFI hotspot.

S104: Collecting password audio information from the user, parsing the password audio information to determine an access code of the WIFI hotspot, and connecting to the WIFI hotspot based on the access code.

In some embodiments, in response to collecting password audio information from the user, the smart device can parse the password audio information to determine an access code of the WIFI hotspot. Then the smart device can connect to the WIFI hotspot based on the access code.

Turning to FIG. 2, a flowchart of a smart networking method are shown in accordance with some other embodiments of the disclosed subject matter. The method can include the following steps.

S201: Obtaining an identification of each available WIFI hotspot.

S202: Detecting a signal strength of each available WIFI hotspot.

In one embodiment, the smart device can scan all available WIFI hotspots, and detect the signal strength of each WIFI hotspot for subsequent broadcasting and selection.

S203: Determining a WIFI hotspot and broadcasting connection information of the available WIFI hotspot.

In one embodiment, if multiple available WIFI hotspots are detected, according to the signal strength of each available WIFI hotspot, a sequence of the multiple available WIFI hotspots can be identified based on an order of the signal strength from strong to weak. A WIFI hotspot that has a strongest signal strength can be identified as an available WIFI hotspot. And the connection information of the WIFI hotspot can be audibly broadcasted to prompt a user to select.

S204: Collecting selection audio information from a user, and parsing the audio information to determine if the user want to select the WIFI hotspot.

S205: Determining a selection result of the WIFI hotspot.

In response to receiving an indication from the audio information that the WIFI hotspot is selected to be connected, determining a selection result is the WIFI hotspot. In response to receiving an indication from the audio information that the WIFI hotspot is not selected, the process can go back to step S203 to determine the next WIFI hotspot in the sequence as the next available WIFI hotspot, and broadcast the connection information for the new available WIFI hotspot. Then steps S204 and S205 can be repeated until a selection result is determined.

In one embodiment, after a selection result is determined, steps S103 and S104 described above in connection with FIG. 1 can be performed to complete a network connection of the smart device.

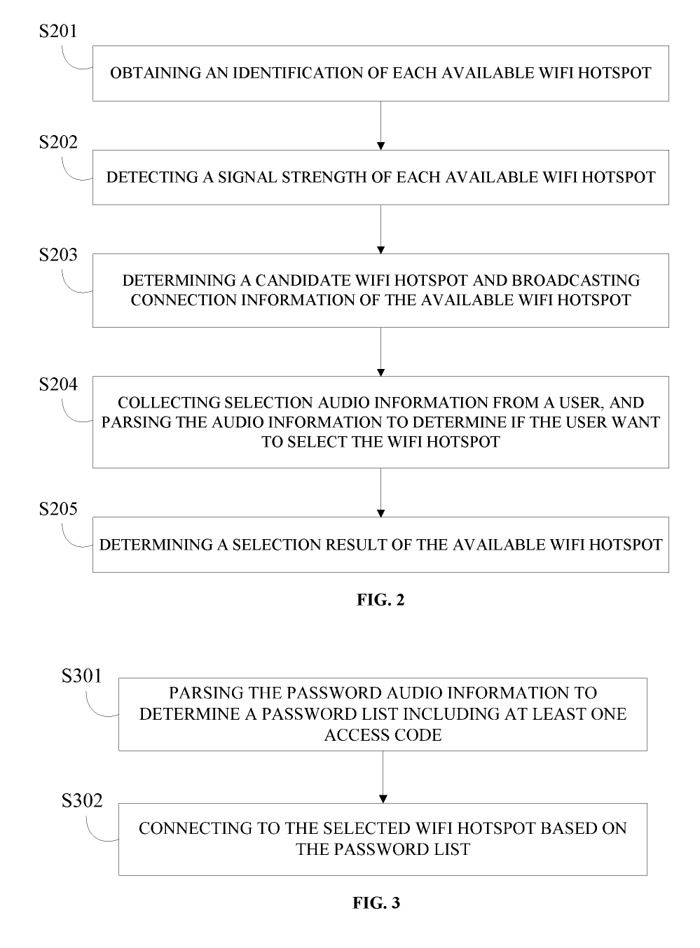

Referring to FIG. 3, a flowchart of a smart networking method is shown in accordance with some other embodiments of the disclosed subject matter. Based on the methods described above in connection with FIGS. 1 and 2, the step S104 can specifically include the following steps.

S301: Parsing the password audio information to determine whether a password list includes at least one access code.

In one embodiment, multiple access codes may be obtained from the parsing of the password audio information due to different languages, accents, and/or intonations. An analysis of the different languages, accents, and/or intonations of the password audio information may be performed to obtain one or more access codes, which are included in a password list. In one embodiment, each obtained access code can associate with a probability index that is determined by a suitable algorithm. Multiple access codes can be ranked based on their associated probability indexes.

S302: Connecting to the selected WIFI hotspot based on the password list.

In one embodiment, after obtaining the password list including at least one access code, the smart device can connect the selected WIFI hotspot based on the password list. The smart device can attempt to connect the selected WIFI hotspot using an access code in the password list one by one following the rank.

Optionally, if the selected WIFI hotspot is successfully connected, a connection success information can be generated and audibly broadcasted to the user to prompt the user that the smart network connection process is complete.

Optionally, if the selected WIFI hotspots is not successfully connected to, a connection failure information can be generated and audibly broadcasted to the user to prompt the user that the intelligent network connection process is failed. The intelligent network connection process can be ended by prompting the user to connect the smart device to the network by an intermediate device.

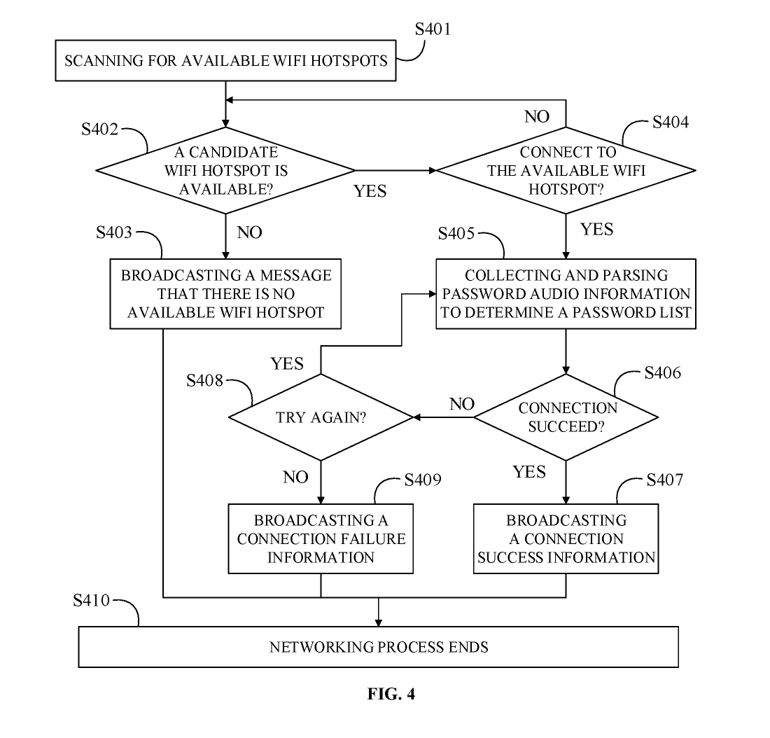

Turing to FIG. 4, a flowchart of an implementation of a smart networking connection process is shown in accordance with some embodiments of the disclosed subject matter. The intelligent networking connection process can be implemented to any suitable smart networking devices, such as smart home appliances, including air conditioners, stereos, refrigerators, etc.

As illustrated, the intelligent networking connection process can include the following steps.

S401: Scanning for available WIFI hotspots.

After a smart device is powered on, the smart device may scan for all available WIFI hotspots. In some embodiments, a smart device may turn on a visual display to indicate that it is scanning for available WIFI hotspots. In one example, the smart device may be an LED lighting device with networking capacities. During the scanning step, the LED lighting device may change its brightness level, light color, or may blink, etc., to indicate that the LED lighting device is scanning for WIFI hotspots. Further, in addition to the main light, the LED lighting device may include a secondary indicator light that may display various light settings to indicate the networking operations executed by the LED lighting device. For example, the secondary indicator light may be an LED light bead placed on one side of the LED lighting device. The secondary indicator light may turn on or blink when the smart lighting device is in the scanning step.

In another example, the smart device may be a smart refrigerator. The smart refrigerator may include a display module. During the scanning step, the smart refrigerator may display an image indicating that it is in the network scanning process (e.g., showing “scanning” or a scanner icon).

S402: Determining if a WIFI hotspot is available.

In one embodiment, if no WIFI hotspot is available (“NO” at S402), step S403 can be performed. The smart device may broadcast a message that there is no available WIFI hotspot. And the networking connection process can end at S410. In some embodiments, in addition to the audio message, the smart device may also turn on a visual display to indicate that it is determining whether a WIFI hotspot is available. In one example, the smart device may be an LED lighting device with networking capacities. The LED lighting device may change its light color, brightness level, or may use a secondary indicator light to indicate it is in the determining step. For example, the LED light device may turn the light into a green light to indicate that a WIFI hotspot is available. The LED light device may turn the secondary indicator light into a green light to indicate that a WIFI hotspot is available.

In another example, the smart device may be a smart refrigerator. The smart refrigerator may include a display module. During the determining step, the smart refrigerator may display an image (e.g., displaying an icon for a network router) indicating that it has identified the available WIFI hotspot.

If only one WIFI hotspot is available, the only one WIFI hotspot is determined as the available WIFI hotspot (“YES” at S402), and then step S404 can be performed.

If more than one WIFI hotspots are available, then the smart device may obtain identifications of all available WIFI hotspots, and a signal strength of each available WIFI hotspot. According to the signal strength of each available WIFI hotspot, the WIFI hotspot can be identified based on an order of the signal strength from strong to weak (“YES” at S402). Then step S404 can be performed.

S404: Determining whether to connect to the WIFI hotspot.

In one embodiment, the smart device can audibly broadcast the identification of the available WIFI hotspot, and ask the user whether the available WIFI hotspot is to be connected. The smart device can then collect audio information from a user, and parse the audio information to determine if the user want to connect the smart device to the WIFI hotspot.

In some embodiments, in addition to the audio message, the smart device may also turn on a visual display to indicate that it is determining whether to connect to the WIFI hotspot. In one example, the smart device may be an LED lighting device with networking capacities. The LED lighting device may change its light color, brightness level, or may use a secondary indicator light to indicate it is in the determining step. For example, the LED lighting device may turn its light into a first color to indicate that it is receiving audio instructions, and it would then turn its light to a second color when it is analyzing and determining whether the user wants to connect based on the received audio information. The LED lighting device may turn the secondary indicator light into a first color to indicate that it is receiving audio instructions, and it would then turn the secondary indicator light to a second color when it is analyzing and determining whether the user wants to connect to the WIFI hotspot based on the received audio information.

In another example, the smart device may be a smart refrigerator. The smart refrigerator may include a display module. During the determining step, the smart refrigerator may display a first image (e.g., a “listening” icon) indicating that it is receiving audio information, and display a second image indicating that it is analyzing and determining whether the user wants to connect to the WIFI hotspot based on the received audio information.

For example, if the audio information includes the word “yes” or any other suitable confirmation phrase or sentence, a positive determination can be made. As another example, if the audio information includes the word “no” or any other repudiation phrase or sentence, a negative determination can be made. The smart device may also display visual indicators, such as different light colors or icons to indicate whether it has received a “yes” or “no.”

In response to receiving a positive determination that the user wants to connect the smart device to the available WIFI hotspot (“YES” at S404), step S405 can be performed.

In response to receiving a negative determination that the user does not want to connect the smart device to the available WIFI hotspot (“NO” at S404), the process can go back to step S402 to determine if there is a next WIFI hotspot is available. For example, a WIFI hotspot has a weaker signal strength can be identified as the next WIFI hotspot.

S405: Collecting and parsing password audio information to determine a password list.

In one embodiment, a password message for prompting the user to provide an access code of the available WIFI hotspot can be generated and broadcasted.

In some embodiments, in response to collecting password audio information from the user, the smart device can parse the password audio information to determine an access code of the available WIFI hotspot.

In some embodiments, multiple access codes may be obtained from the parsing of the password audio information due to different languages, accents, and/or intonations. An analysis of the different languages, accents, and/or intonations of the password audio information may be performed to obtain one or more access codes, which are included in a password list. In one embodiment, each obtained access code can associate with a probability index that is determined by a suitable algorithm. Multiple access codes can be ranked based on their associated probability indexes.

In some embodiments, a smart device may also turn on a visual display to indicate that it is collecting and parsing audio information to determine a password list. In one example, the smart device may be an LED lighting device with networking capacities. The LED lighting device may change its light color, brightness level, or may use a secondary indicator light to indicate it is in the collecting and parsing step. For example, the LED lighting device may turn the light into a first color to indicate that it is receiving audio instructions, and it would then turn the light to a second color when it is analyzing and determining passwords based on the received audio information. The LED lighting device may turn the secondary indicator light into a first color to indicate that it is receiving audio instructions, and it would then turn the secondary indicator light to a second color when it is determining passwords based on the received audio information.

In another example, the smart device may be a smart refrigerator. The smart refrigerator may include a display module. During the determining step, the smart refrigerator may display a first image (e.g., a “listening” icon) indicating that it is receiving audio information, and display a second image indicating that it is analyzing and determining passwords based on the received audio information.

S406: Connecting to the WIFI hotspot based on the password list.

In one embodiment, after obtaining the password list including at least one access code, the smart device can connect the WIFI hotspot based on the password list. The smart device can attempt to connect the WIFI hotspot using an access code in the password list one by one following the rank.

In one embodiment, while the smart device is in a connecting process, a message for prompting the user to wait can be generated and broadcasted.

In some embodiments, a smart device may also turn on a visual display to indicate whether it has successfully connected to the WIFI hotspot. In one example, the smart device may be an LED lighting device with networking capacities. The LED lighting device may change its light color, brightness level, or may use a secondary indicator light to indicate it is in the connecting step. For example, the LED lighting device may turn the light into a first color during the connecting step. The LED lighting device may also turn the secondary indicator light into a first color during the connecting step.

In another example, the smart device may be a smart refrigerator. The smart refrigerator may include a display module. During the determining step, the smart refrigerator may display a first image (e.g., a “connecting” icon) during the connecting step.

If the WIFI hotspot is successfully connected (“YES” at S406), step S407 can be performed. The smart device may broadcast a connection success information. For example, a connection success information can be generated and audibly broadcasted to the user to prompt the user that the intelligent network connection process is complete. And the networking connection process can end at S410.

If the selected WIFI hotspots is not successfully connected (“NO” at S406), step S408 can be performed. The smart device can determine whether to connect to the available WIFI hotspots again.

In one embodiment, the smart device can audibly ask the user whether the available WIFI hotspot is to be connected. Specifically, the smart device can audibly broadcast that an access code for the available WIFI hotspot is not correct, and ask the user to input password audio information again.

Then the smart device can collect response audio information from the user, and parse the response audio information to determine if the user want to connect the smart device to the available WIFI hotspot.

In response to receiving a positive determination that the user want to connect the smart device to the available WIFI hotspot again (“YES” at S408), the process can go back to step S405 to collect password audio information from the user again.

In response to receiving a negative determination that the user does not want to connect the smart device to the available WIFI hotspot (“NO” at S408), the process can perform step S409: Broadcasting a connection failure information. For example, a connection failure information can be generated and audibly broadcasted to the user. As another example, the smart device may broadcast another message to prompt the user to connect the smart device to the network by an intermediate device. And the networking connection process can end at S410.

In some embodiments, a smart device may turn on a visual display to indicate that a connection to the WIFI hotspot is completed or failed. In one example, the smart device may be an LED lighting device with networking capacities. The LED lighting device may change its light color, brightness level, or may use a secondary indicator light to indicate the connection status. For example, the LED lighting device may turn the light into a first color to indicate that the connection to the WIFI hotspot is completed. It may turn the light to a second color the connection has failed. The LED lighting device may turn the secondary indicator light into a first color to indicate that it has successfully connected to the WIFI hotspot, and it would then turn the secondary indicator light to a second color to indicate that it has failed to connect to the WIFI hotspot.

In another example, the smart device may be a smart refrigerator. The smart refrigerator may include a display module. During the determining step, the smart refrigerator may display a first image (e.g., a “connection” icon) indicating that it has connected to the WIFI hotspot, and display a second image indicating that it has failed to connect to the WIFI hotspot.

As described above, the disclosed subject matter provides a smart networking method. The method includes obtaining an identification of a WIFI hotspot; broadcasting connection information that includes the identification of the WIFI hotspot to prompt a user to choose whether to connect to the WIFI hotspot; collecting selection audio information from the user, and parsing the audio information to obtain a selection result of the user; in response to receiving an indication from the selection result that the WIFI hotspot is selected to be connected, generating a password message for prompting the user to provide an access code of the WIFI hotspot, and broadcasting the password message; and collecting password audio information from the user, parsing the password audio information to determine an access code of the available WIFI hotspot, and connecting to the WIFI hotspot based on the access code.

In some embodiments consistent with the present disclosure, the smart networking method may combine the audio and visual prompts so that a user may hear as well as see the steps the smart device takes to scan and connect to a WIFI hotspot. For each step of the networking method, the smart device may provide audio and visual prompts to request information from the user, and indicate its status in making network connections, requesting information, receiving information, or analyzing received information.

Comparing to existing networking method using intermedia equipment, the disclosed method can be implemented in situations that smart phones or tablet PCs are not available. A smart device, such as a smart home appliance, can realize a wireless connection to a WIFI hotspot through voice interactions by using the disclosed method. Therefore, the disclosed method can simplify a smart networking process, expand an application scenario of a smart device, and provide better user experience.

It should be noted that the above steps of the flowchart diagrams of FIGS. 1-4 can be executed or performed in any order or sequence not limited to the order and sequence shown and described in the figure. Also, some of the above steps of the flow diagram of FIGS. 1-4 can be executed or performed substantially simultaneously where appropriate or in parallel to reduce latency and processing times. Furthermore, it should be noted that FIGS. 1-4 are provided as examples only. At least some of the steps shown in the figures may be performed in a different order than represented, performed concurrently, or altogether omitted.

It also should be noted that the above steps of the flowchart diagrams of FIGS. 1-4 can be executed or performed by hardware, such as one or more hardware processors, or by a combination of hardware and software, such as computer readable media applied on one or more hardware processors.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, and/or any other suitable media), optical media (such as compact discs, digital video discs, Blu-ray discs, and/or any other suitable optical media), semiconductor media (such as flash memory, electrically programmable read only memory (EPROM), electrically erasable programmable read only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

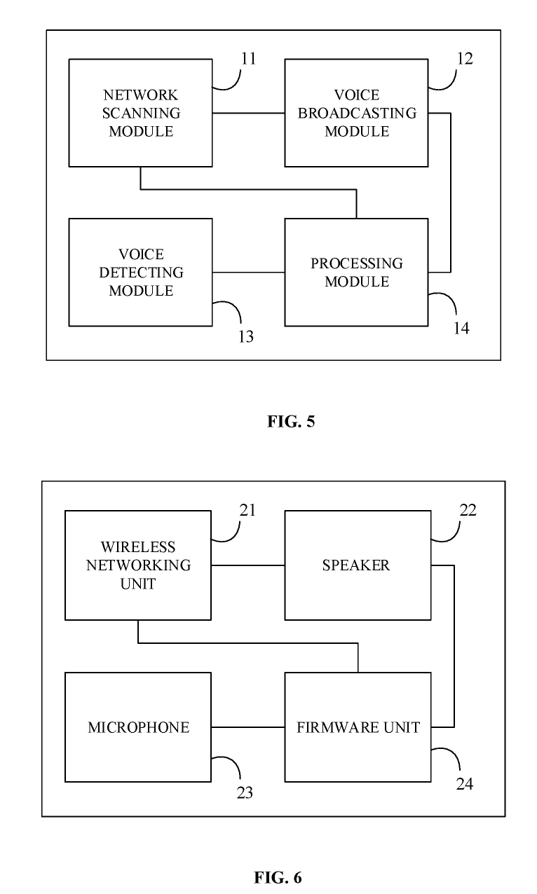

Turning to FIGS. 5-7, schematic structural diagrams of a smart device are shown in accordance with some embodiments of the disclosed subject matter.

As illustrated in FIG. 5, a disclosed smart device may include a network scanning module 11, a voice broadcasting module 12, a voice detecting module 13, and a processing module 14. Each of these modules may include software programs and hardware modules combined to implement the functions as described below.

Processing module 14 can be connected respectively with network scanning module 11, voice broadcasting module 12, and voice detecting module 13. Network scanning module 11 is connected with voice broadcasting module 12.

Network scanning module 11 may be software programs and hardware components that are controlled by processing module 14. For example, network scanning module may be a wireless scanner (e.g., a WIFI scanner) with relevant managing software programs. Network scanning module 11 may receive wireless networking information from its scanning component. Network scanning module 11 may also send the wireless networking information to processing module 14 through a wireless or wired communication channel. For example, network scanning module 11 can scan available WIFI hotspots, obtain an identification of each available WIFI hotspot, and detect a signal strength of each available WIFI hotspot.

Voice broadcasting module 12 is configured for broadcasting a voice message transmitted from processing module 14. For example, voice broadcasting module 12 may include a speaker and the related software programs. Voice broadcasting module 12 can audibly broadcast an identification for an available WIFI hotspot. As another example, voice broadcasting module 12 can audibly broadcast a request message, asking if a WIFI hotspot is to be selected. In yet another example, voice broadcasting module 12 can audibly broadcast another request message asking a user to provide an access code of the selected WIFI hotspot. In yet another example, voice broadcasting module 12 can audibly broadcast connection-successful information, or connection-failure information.

Voice detecting module 13 is configured for collecting user voice information, and transmitting the user voice information to processing module 14 for analysis. Voice detection module 13 may include a microphone, and software need to process voice information collected through the microphone.

Processing module 14 is configure for determining an available WIFI hotspot based on the wireless networking information transmitted from network scanning module 11. For example, processing module 14 can rank multiple WIFI hotspots based on the detected signal strength of each available WIFI hotspot. Processing module 14 can determine the available WIFI hotspot based on the rank and collected user voice information. For example, a WIFI hotspot with the strongest signal strength can be identified as the available WIFI hotspot in a default situation. As another example, a WIFI hotspot indicated by the collected user voice information can be identified as the available WIFI hotspot.

Processing module 14 is further configure for generating one or more voice messages and transmitting the one or more voice messages to voice broadcasting module 12. For example, a voice message including one or more identifications of available WIFI hotspots can be generated for prompting a user to select a WIFI hotspot that is to be connected by a smart device. As another example, a voice message requiring a user to provide an access code of a selected WIFI hotspot can be generated. As yet another example, a voice message indicating that a WIFI connection is successful or not can be generated.

Processing module 14 is further configure for analyzing user voice information transmitted from voice detecting module 13. For example, processing module 14 can parse user voice information to determine if the available WIFI is selected by a user or not. As another example, processing module 14 can parse user voice information to determine a password list include at least one access code for connecting to a selected WIFI hotspot.

Referring to FIG. 6, a schematic structural diagram of a smart device is shown in accordance with some embodiments of the disclosed subject matter. As illustrated in FIG. 6, a disclosed smart device can include a wireless networking unit 21, a speaker 22, a microphone 23, and a firmware unit 24.

In some embodiments, network scanning module 11 in FIG. 5 can be a wireless networking unit 21 in FIG. 6. Voice broadcasting module 12 in FIG. 5 can be a speaker 22 in FIG. 6. Voice detecting module 13 in FIG. 5 can be a microphone 23 in FIG. 6. Processing module 14 in FIG. 5 can be a firmware unit 24 in FIG. 6.

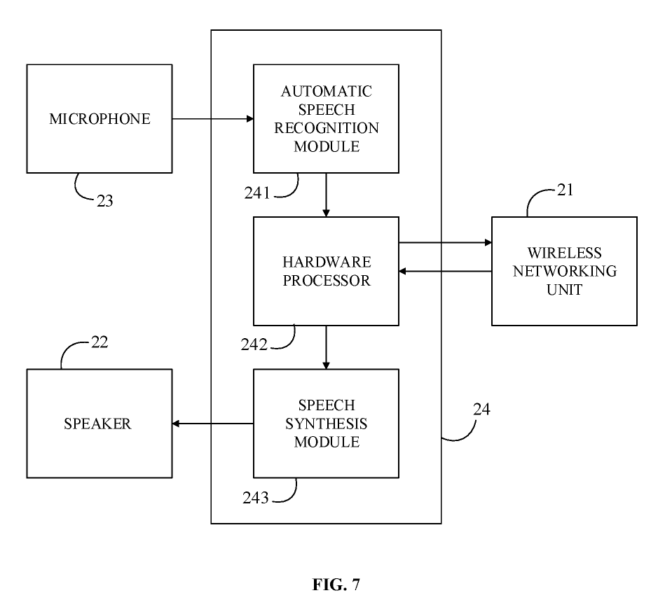

Referring to FIG. 7, a data flow diagram of the smart device is shown in accordance with some embodiments of the disclosed subject matter.

In some embodiments, firmware unit 24 can include an automatic speech recognition (ASR) module 241, a hardware processor 242, and a speech synthesis module 243.

Voice signal from a user can be collected by microphone 23. Automatic speech recognition (ASR) module 241 can process and recognize the voice signal to generate user voice information, such as a user's command, a password list, etc. The user voice information can be sent to hardware processor 242.

Based on the wireless networking information obtained from wireless networking unit 21, and the user voice information transmitted from automatic speech recognition (ASR) module 241, hardware processor 242 can determine a response message, such as a request message, a confirmation message, an error message, etc. The response message can be sent to speech synthesis module 243 to be transformed into voice signals. The transformed voice signals can be sent to speaker 22 to be audibly broadcasted to the user. Automatic speech recognition (ASR) module 241 and speech synthesis module 243 may include software programs that can be executed by the hardware processor 242 to implement the speech recognition and the speech synthesizing functions. In one example, microphone 23 may collect audio information from a user. Automatic speech recognition module 241 may include software programs, when executed by the hardware processor that can receive the audio information, parse the collected audio information, and identify works or phrased in the collected audio information. Speech synthesis module 243 may include software programs, when executed by the hardware processor, that can synthesize information received from the hardware processing 242 into signals representing audible words or phrases, and send the signals for the speaker 22.

It should be noted that, hardware processor 242 can be any suitable processor, such as a central processing unit (CPU), a digital signal processor (DSP), an application specific integrated circuit (ASIC), a general purpose processor, etc.

As described above, the disclosed smart device can perform any of the smart networking method described in connection of FIGS. 1-4. The smart device can include: a processing module; a network scanning module configured for obtaining wireless networking information and transmitting the wireless networking information to a processing module; a voice broadcasting module configured for broadcasting a voice message transmitted from the processing module; and a voice detecting module configured for collecting user voice information and transmitting the user voice information to the processing module. The processing module determines an available WIFI hotspot based on the wireless networking information transmitted from network scanning module, generates a voice message and transmitting the voice message to voice broadcasting module, and analyzes the user voice information transmitted from voice detecting module.

Comparing to existing smart devices, the disclosed smart device can initiate a wireless network connection without using an intermedia device, such as a smart phone or a tablet PC. The disclosed smart device, such as a smart home appliance, can realize wireless connections to a WIFI hotspot through voice interactions. Therefore, the disclosed smart device can implement a smart networking method that is interactive and user friendly, and thus provide better user experience.

The descriptions of the examples described herein (as well as clauses phrased as “such as,” “e.g.,” “including,” and the like) should not be interpreted as limiting the claimed subject matter to the specific examples; rather, the examples are intended to illustrate only some of many possible aspects.

Accordingly, a smart lighting device, a related control terminal, and a related lighting system are provided.

Although the disclosed subject matter has been described and illustrated in the foregoing illustrative embodiments, it is understood that the present disclosure has been made only by way of example, and that numerous changes in the details of embodiment of the disclosed subject matter can be made without departing from the spirit and scope of the disclosed subject matter, which is only limited by the claims which follow. Features of the disclosed embodiments can be combined and rearranged in various ways. Without departing from the spirit and scope of the disclosed subject matter, modifications, equivalents, or improvements to the disclosed subject matter are understandable to those skilled in the art and are intended to be encompassed within the scope of the present disclosure.

1. A smart networking method, comprising:
obtaining an identification of a first available WIFI hotspot;
broadcasting connection information comprising the identification of the first available WIFI hotspot to prompt a user to choose whether to connect to the first available WIFI hotspot;
collecting selection audio information from the user, and parsing the audio information to obtain a selection result of the user;
in response to receiving the selection result selecting to connect to the first available WIFI hotspot, generating a password message for prompting the user to provide an access code of the first available WIFI hotspot, and broadcasting the password message; and
collecting password audio information from the user, parsing the password audio information to determine an access code of the available WIFI hotspot, and connecting to the first available WIFI hotspot based on the access code.

2. The smart networking method of claim 1, further comprising:
obtaining a plurality of identifications of a plurality of available WIFI hotspots; and
detecting a signal strength of each available WIFI hotspot; wherein the plurality of available WIFI hotspots including the first available WIFI hotspot.

3. The smart networking method of claim 2, further comprising ranking the plurality of available WIFI hotspots based on the signal strengths of the available WIFI hotspots.

4. The smart networking method of claim 3, further comprising identifying the first available WIFI hotspot from the plurality of available WIFI hotspots based on the rank.

5. The smart networking method of claim 4, wherein the first available WIFI hotspot has a strongest signal strength.

6. The smart networking method of claim 4, wherein the first available WIFI hotspot is identified based on the rank and the selection audio information from the user.

7. The smart networking method of claim 1, further comprising:
parsing the password audio information to determine whether a password list includes at least one access code; and
connecting to the first available WIFI hotspot based on the password list.

8. The smart networking method of claim 1, further comprising generating and broadcasting connection-successful information when the first available WIFI hotspot is being successfully connected to.

9. The smart networking method of claim 1, further comprising generating and broadcasting connection-failure information when the first available WIFI hotspot is not successfully connected to.

10. A smart device, comprising:
a processing module;
a network scanning module configured for obtaining wireless networking information and transmitting the wireless networking information to the processing module;
a voice broadcasting module configured for broadcasting a voice message transmitted from the processing module; and
a voice detecting module configured for collecting user voice information and transmitting the user voice information to the processing module;
wherein the processing module is configured for identifying a first available WIFI hotspot based on the wireless networking information transmitted from the network scanning module, generating a voice message and transmitting the voice message to the voice broadcasting module, and analyzing the user voice information transmitted from the voice detecting module.

11. The smart device of claim 10, wherein the wireless networking information comprises an identification of the first available WIFI hotspot and a signal strength of the first available WIFI hotspot.

12. The smart device of claim 11, wherein the processing module is further configured for ranking a plurality of available WIFI hotspots based on the signal strengths of the available WIFI hotspots.

13. The smart device of claim 10, wherein the voice message comprises the identification for the first available WIFI hotspot, and a first request message for asking whether the first available WIFI hotspot is to be selected.

14. The smart device of claim 13, wherein the voice message further comprises a second request message for asking a user to provide an access code of the first available WIFI hotspot.

15. The smart device of claim 14, wherein the voice message further comprises connection-successful information.

16. The smart device of claim 14, wherein the voice message further comprises connection-failure information.

17. The smart device of claim 10, wherein the processing module is further configured for parsing the user voice information to determine whether a password list includes at least one access code for connecting to the first available WIFI hotspot.

18. The smart device of claim 10, wherein the voice broadcasting module comprises at least one speaker.

19. The smart device of claim 10, wherein the voice detecting module comprises at least one microphone.

20. The smart device of claim 10, wherein the processing module comprises an automatic speech recognition module, a hardware processer, and a speech synthesis module.
